(19) United States
(12) Patent Application Publication
(10) Pub. No.: US 2026/0059235 A1
(43) Pub. Date: Feb. 26, 2026

(54) A MICROPHONE DEVICE

(71) Applicant: GN Hearing A/S, Ballerup (DK)

(72) Inventors: Daniel Gert NIELSEN, Ballerup (DK); Facundo RAMÓN, Ballerup (DK); Robert JAMES, Ballerup (DK); Jens KIRKELUND, Ballerup (DK)

(21) Appl. No.: 19/272,073

(22) Filed: Jul. 17, 2025

(30) Foreign Application Priority Data
Aug. 23, 2024 (EP) 24196281.0

(51) Int. Cl. H04R 1/40; H04R 1/08

(52) U.S. Cl. CPC H04R 1/406; H04R 1/08; H04R 2201/401

(57) ABSTRACT

A microphone device having a housing comprising a first external surface part and a second external surface part opposing said first external surface part so that an open sound reception cavity extends 360 degrees around a vertical centre axis from an outer circumference towards the centre axis. A microphone array comprising at least two microphones are arranged in the cavity with the microphones distributed on a circle with the centre axis as centre. The microphones are arranged at least 25% of the distance between the outer circumference and the vertical centre axis from the outer circumference.

This application claims the benefit of priority from European Patent Application No. 24196281.0, filed on 23 Aug. 2024, the entire contents of which are incorporated herein by reference.

The present invention relates to microphone devices, in particular, but not exclusively microphone devices for tables in conference rooms for videoconferencing and the like.

Modern conference rooms are typically adapted not only for physical presence of participants but also for videoconferencing, allowing participants at remote locations to be seen and heard by the persons physically present and vice versa allowing sound and video of the persons present to be captured and transmitted to the participants at their remote locations. Typically, in the conference room a display screen will be arranged on a wall or a movable stand allowing it to be seen by participants sitting around a table and allowing a camera arranged in conjunction with the display screen to capture live images of the participants. Microphones may also be arranged in conjunction with the camera and/or the display screen, but often a microphone device is placed in a central location on the table to reduce the maximum distance from the speakers to the microphone device, i.e. those speakers farthest away from the display screen in order to get a suitable sound level from the speakers that is not drowned out by other noises, sound reflections etc. in the conference room.

In order for such microphone devices to receive an approval by the providers of videoconferencing software systems to be used with their systems the microphone devices must live up to certain standards set by the providers, e.g. having essentially same sensitivity in all 360 degree horizontal directions but not in the vertical, where a higher sensitivity in a small acute angle above the table is preferred, i.e. where the heads of the speakers sitting around the table are most likely be. At higher angles a reduced sensitivity is preferred, in order to suppress noise from ventilation, fans etc. typically located in or close to the ceiling.

An example of an table microphone device with same sensitivity in all 360 degree horizontal directions and vertical suppression is known from U.S. Pat. No. 4,434,507. This device comprises a tall cylindrical body with a single microphone arranged on the cylinder axis. Sound is guided to the central microphone via a circumferential acoustic pathway arranged at the top of the cylindrical body away from the tabletop. The use of a high cylinder and the use of a single microphone only presents some drawbacks in terms of reflections of sound off the tabletop and in terms of the advanced audio processing taking place in the videoconferencing software systems on order to enhance and emphasize speech from specific persons.

Based on this, it is the object of the invention to provide a microphone device which has a good sensitivity in all directions in a plane surrounding the microphone device and in narrow opening angle with respect to that plane, while also providing wide possibilities of conference specific audio processing in the videoconferencing system.

According to a first aspect of the invention this and other objects is achieved with a microphone device comprising a vertical centre axis, a housing comprising a first external surface part and a second external surface part opposing said first external surface part so that an open sound reception cavity extends 360 degrees around the vertical centre axis from an outer circumference towards the centre axis, a microphone array comprising at least two microphones arranged in the cavity, the microphones being distributed on a circle with the centre axis as centre, wherein the microphones are arranged at least 25% of the distance between the outer circumference and the vertical centre axis from the outer circumference.

In this way it becomes possible to provide a sound reception cavity with 360 degrees opening in turn allowing essentially unobstructed passage of sound to the microphones in a narrow opening angle from the horizontal plane, while at that same time provide microphones that enable post processing based on e.g. phase or amplitude differences between received acoustic signals in order to e.g. dynamically achieve directionality in all 360 degrees direction of the horizontal plane so as to better pick up sounds from persons speaking or other relevant sounds.

In an embodiment of the first aspect of the invention, the first external surface part is separated from second external surface part by a spacing distance providing the sound reception cavity between the opposing first and second external surface parts. This allows the attenuation of undesired sounds in the vertical directions thus allowing the microphone device to have an increased sensitivity to sounds emanating from the narrow opening angle bout the horizontal plane as compared to sounds emanating from outside directions such as ceiling fans, vents or air conditioners.

In an embodiment of the first aspect of the invention, the spacing distance increases with increasing distance from the centre axis, so as to provide two sloping walls. This allows the sounds to be directed to the microphones in a funnel-like manner thereby amplifying the sounds with around e.g. 3 to 5 dB at at least some frequencies before they reach the microphones as compared to a situation where microphoned are arranged on the top of the device.

In an embodiment of the first aspect of the invention, the microphones are arranged on one and the same external surface part. This allows the electrical wiring to the microphones to be drawn within one and the same housing part.

In an embodiment of the first aspect of the invention, the first external surface part is provided on a first housing part and the second external surface part is provided on a second housing part, where the first housing part is separated from second housing part. This allows simplification of the manufacturing as the two housing parts may be manufactured and prepared separately, e.g. before they are joined to form the microphone device.

In an embodiment of the first aspect of the invention, at least one of the first housing part and second housing part comprises a rotational symmetry about the centre axis. Rotational symmetry, and especially a circular rotational symmetry gives good and uniform acoustic response in all 360 degrees.

Accordingly, in an embodiment of the first aspect of the invention, at least one of the first housing part and second housing part comprises a circular periphery.

In an embodiment of the first aspect of the invention, at least one of said first and second external surface parts are delimited by the circular periphery this allows the full surface of each housing part providing the cavity to be used for directing the sound to the microphones.

In an embodiment of the first aspect of the invention, the microphone device is adapted to be placed on a horizontal surface, so that the first housing part provides an upper part of the microphone device, and the second housing part provides a lower part of the microphone device. This makes the microphone useful and versatile for conference rooms as it may freely be placed on a table at which participants are sitting speaking.

In an embodiment of the first aspect of the invention, the first and second housing parts are separated by at least one column. Using one or more columns is an efficient way of providing the spacing without disturbing the essentially unobstructed passage of sound to the microphones. If only a single column is used, this column could but need not coincide with the centre axis. Using several columns these could be arranged symmetrically about the centre axis for stability and good aesthetic appearance of the microphone device.

In an embodiment of the first aspect of the invention, the microphone device, comprising a further microphone arranged on the centre axis. A centrally microphone may serve as reference when processing date for directionality.

In an embodiment of the first aspect of the invention, the number of microphones is four or more. Four microphones have been found to be a good compromise for directionality and sensitivity versus cost and processing power.

In an embodiment of the first aspect of the invention, the microphones are arranged on the upper part of the microphone device. This may be used to make them less sensitive to effects from the base, such as a table, on which the microphone device is located.

The microphones may be arranged in a maximum distance of 40, 30 or 20 mm above a surface on which the microphone device is arranged.

The invention will now be described in greater detail based on non-limiting exemplary embodiments and with reference to the schematic drawings on which:

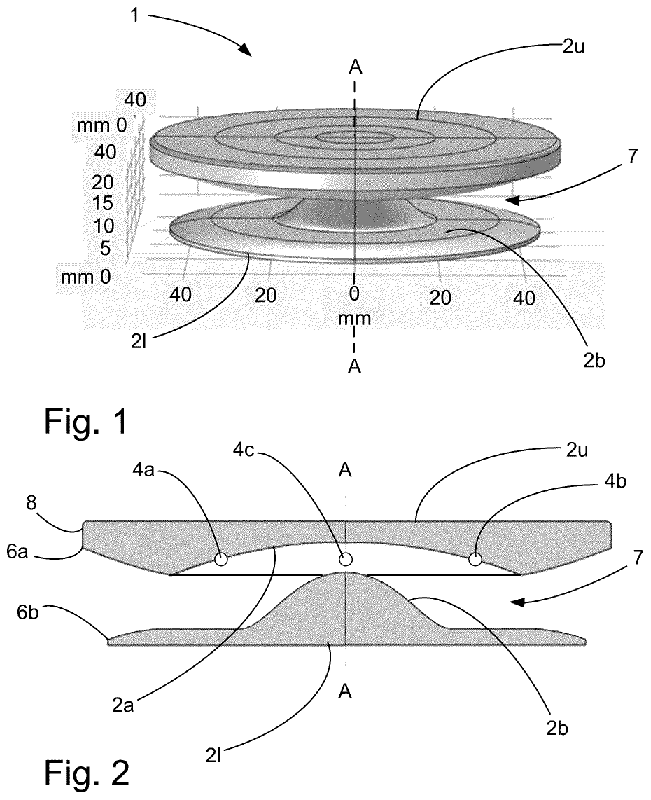

FIG. 1 is a perspective view of a microphone device according to the invention,

FIG. 2 is a schematic cross-section of the microphone device of FIG. 1 showing the outline but not the interior,

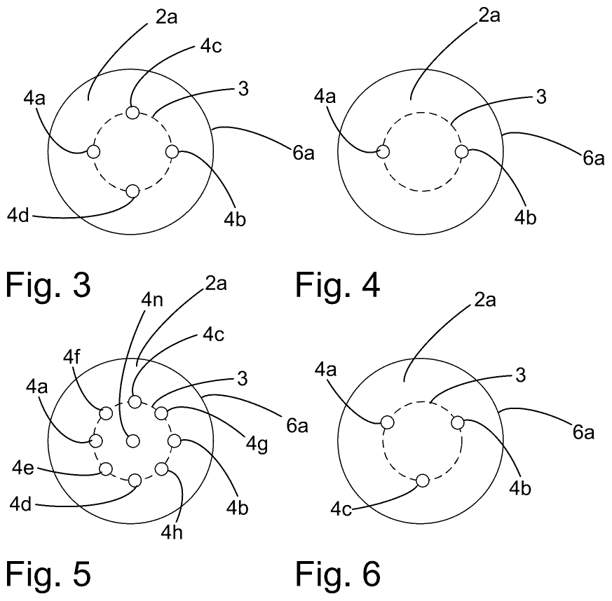

FIG. 3 is a schematic representation of the location of the four microphones of FIG. 2

FIG. 4 is a schematic representation of a lay-out of with the locations of two microphones,

FIG. 5 is a schematic representation of a lay-out of with the locations of nine microphones, including a centre microphone,

FIG. 6 is a schematic representation of a lay-out of with the locations of three microphones, and

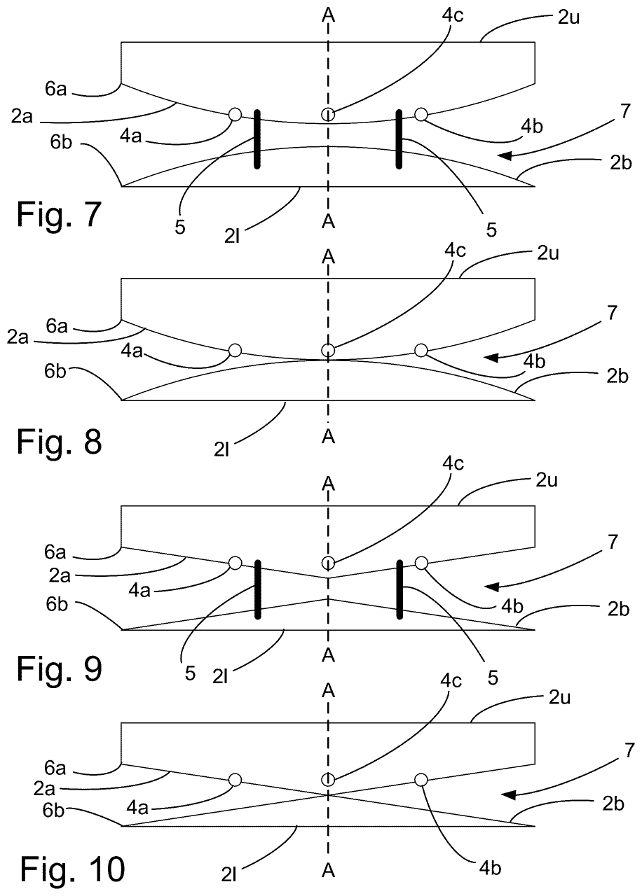

FIGS. 7-14 are schematic side views of alternative shapes of the microphone device according to the invention.

Turning first to FIG. 1 a perspective view of a microphone device 1 according to the invention is shown. The microphone device comprises a housing which may comprise two separate housing parts 2u, 2l. As can be seen the microphone device generally has rotational symmetry about a centre axis A-A. In the illustrated embodiments the rotational symmetry is circular, but it could comprise any order of rotational symmetry from second order and up. In normal intended use when the microphone device 1 is placed on e.g. a tabletop the centre axis A-A is vertical. In this description references such as horizontal, vertical, above below, etc. are used in accordance with this intended use.

As can be seen in FIGS. 1, 2 and 7-14 the housing parts 2u, 2l comprising a first external surface part 2a and a second external surface part 2b opposing said first external surface part 2a so that an open sound reception cavity 7 extends 360 degrees around the vertical centre axis (A-A) from an outer circumference 6a of the external surfaces 2, 2b towards the centre axis (A-A). In the sound reception cavity a microphone array is arranged. The microphone array comprises at least two microphones 4a, 4b. In the embodiment of FIG. 2 there are four microphones, of which three microphones 4a, 4b, 4c are visible. The microphones 4a, 4b, 4c are in this and other embodiments distributed on a circle 3 with the centre axis A-A as centre. As illustrated in FIGS. 3 to 6 there may be fewer or more than four microphones 4a-4d, e.g. two microphones 4a, 4b as illustrated in FIG. 4 or eight microphones 4a, 4b, . . . 4h plus one optional central microphone 4n, preferably co-incident with the central axis A-A, as illustrated in FIG. 5. The number of microphones in the microphone array may be odd as well as even.

The microphones 4a, 4b . . . 4h are arranged at least 25% of the distance between the outer circumference 6a of the surface 2a on which they are located and the vertical centre axis A-A from the outer circumference 6a. In the illustrated example the microphones 4a, 4b . . . 4h are arranged at approximately 50% of the distance from the outer circumference 6a of the surface 2a towards the centre axis A-A.

As can be seen in FIGS. 2, 7 and 9 the first external surface part 2a is separated from second external surface part 2b by a spacing distance that varies with the radial distance from the centre axis A-A. The variation may be a monotonous increase as show in FIGS. 7-14. Preferably, the spacing increases with the radial distance as shown in FIGS. 7, 9, 11 and 13 but still leaves a central horizontal passage, narrower that the spacing at the circumferences 6a, 6b of the external surface parts 2a, 2b, so that sound arriving from one side of the centre axis A-A may pass generally unobstructed to any microphones on the opposite side of the centre axis A-A, i.e. in FIGS. 7, 9, 11, and 13 from the left-hand side of the microphone device 1 in the figure to the microphone 4b on the right-hand side of the axis A-A in the figure. To keep the two external surface parts 2a, 2b apart, columns acting as spacers are provided between the two housing parts 2u, 2l so that the first housing part 2u is separate from the second housing part 2l. These columns 5 may be made thin and arranged so that they do not interfere with the sound waves. They need not be vertical, i.e. extend in parallel with the centre axis A-A.

Alternatively, the two housing parts 2u, 2l may meet or be joined at the centre axis A-A as shown in FIGS. 8, 10, 12 and 14, so that no spacing is found there. This allows the omission of the spacer columns 5 but makes the positioning of a central microphone 4n difficult or even impossible. Also in these embodiments, the spacing preferably increases with radial distance from the centre axis A-A, albeit starting from zero.

This change in distance between first surface part 2a and the second surface part 2b, i.e. narrowing down from the circumferences 6a, 6b towards the microphone array allows amplification of the sound, at least for some frequencies, allowing improved sensitivity in e.g. the frequency range of human speech, at least when the dimensions are of the same magnitude as indicated in FIG. 1. Furthermore, because the microphones 4a, 4b, . . . 4h, and optionally microphone 4n are arranged away from the circumference 6a of the surface 2a, the housing parts 2u, 2l obstruct and attenuate sound coming from more vertical directions but favour sounds from more horizontal directions where speakers at likely to be found.

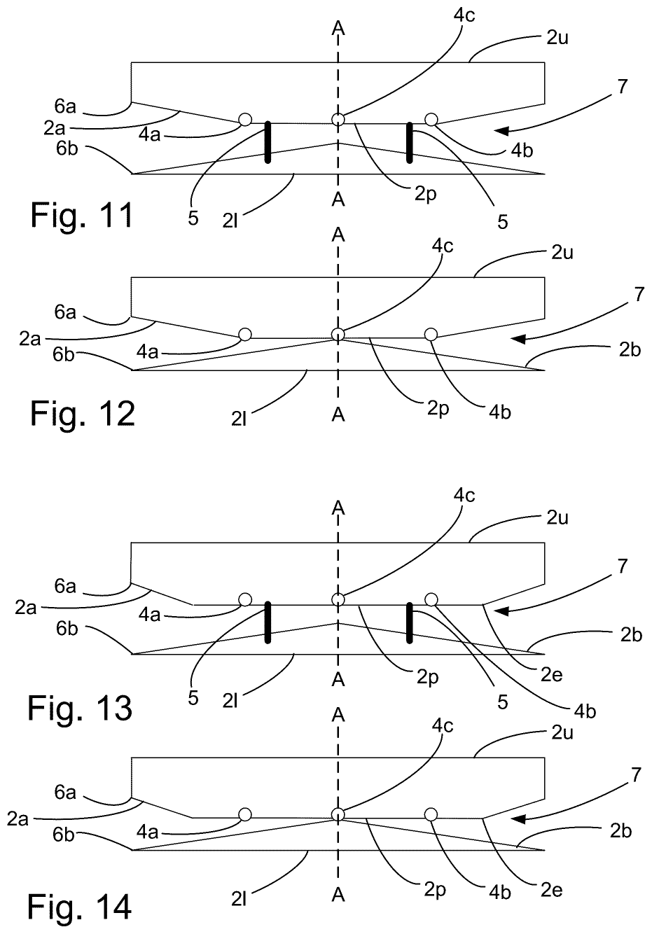

As illustrated in FIGS. 11-14 the first external surface 2a may include a horizontal planar area 2p. The microphones 4a, 4b, . . . 4h may arranged within the horizontal planar area 2p as illustrated in FIGS. 13 and 14, at the edge 2e or periphery of the horizontal planar area 2p as illustrated in FIGS. 11 and 12, or even on the sloped surface between the edge 2e or periphery of the planar area 2p and the circumference 6a (not illustrated). The use of such a horizontal planar area 2p is not limited to use with the cone shaped surface as illustrated in FIGS. 11-14 but could also be implemented in conjunction with curved surfaces, be it curved as the spherical segments in FIGS. 7 and 8 or other curvatures.

It is not excluded that in some embodiments the second external surface 2b could also or instead include a planar surface (not illustrated).

Irrespective whether there is a central bulge as in FIG. 2 on the external surface part 2b of the lower housing part 2l, the external surface is cone shaped as in FIGS. 9 and 14, smoothly curved as the spherical segments in FIGS. 7 and 8, or some other shape of the sloping wall formed, the lower housing part 2l preferably presents a very low and if necessary rounded edge 6b to limit the discontinuity between the table top or other surface on which the microphone device is placed and the second surface 2b in turn avoiding undesired sound diffraction and reflection effects. This edge 6b defines the circumference and delimits the second external surface part 2b.

Being away from the tabletop or other reflecting surfaces, the upper housing part 2u does not suffer from the same constraints on the periphery of the sloping walls, meaning it may be made more voluminous by e.g. having a more or less vertical circumferential wall 8, the transition to which delimits the first external surface part 2a, in turn allowing space for the power supply, such as rechargeable batteries, and the necessary electronics for conversion of sound to electrical signals, signal processing circuitry, and wireless transmitters, etc.

With all electronics located in the upper housing part 2u, the microphones 4a, 4b, . . . 4h and 4n are preferably arranged on the first external surface part 2a so that electrical wiring need not be drawn between he upper and lower housing parts 2u, 2l. The opposite, i.e. all electronics in the lower housing part 2l and the microphones on the second surface 2b, is of course not excluded and neither is a mix with microphones on the external surface parts 2a, 2b of one housing part 2u, 2l and all or some of the electronics in the other housing part 2u, 2l.

The upper housing part 2u and the lower housing part 2l need not have the same circumferential shape of if so the same dimensions. As can be seen in FIGS. 1 and 2 the peripheral circumference 6b of the external surface part 2b is smaller than the peripheral circumference 6a of the external surface part 2a.

If the lower housing part 2l is not used for supporting microphones or accommodating electronics, it need not have an internal cavity but may be solid. Alternatively, an internal cavity could be loaded with a weight body to lower the centre of gravity of the microphone device for added stability, and/or filled with a vibration damping material.

1. A microphone device comprising
a vertical centre axis,
a housing comprising a first external surface part and a second external surface part opposing said first external surface part so that an open sound reception cavity extends 360 degrees around the vertical centre axis from an outer circumference towards the centre axis,
a microphone array comprising at least two microphones arranged in the cavity, the microphones being distributed on a circle with the centre axis as centre,
wherein the microphones are arranged at least 25% of the distance between the outer circumference and the vertical centre axis from the outer circumference.

2. A microphone device according to claim 1, wherein the first external surface part is separated from second external surface part by a spacing distance providing the sound reception cavity between the opposing first and second external surface parts.

3. A microphone device according to claim 2, wherein the spacing distance increases with increasing distance from the centre axis, so as to provide two sloping walls.

4. A microphone device according to claim 1, wherein the microphones are arranged on one and the same external surface part.

5. A microphone device according claim 1, wherein the first external surface part is provided on a first housing part and the second external surface part is provided on a second housing part, where the first housing part is separated from second housing part.

6. A microphone device according to claim 5, wherein at least one of the first housing part and second housing part comprises a rotational symmetry about the centre axis.

7. A microphone device according to claim 6, wherein at least one of the first housing part and second housing part comprises a circular periphery.

8. A microphone device according to claim 7, wherein at least one of said first and second external surface parts are delimited by the circular periphery.

9. A microphone device according to claim 5, which is adapted to be placed on a horizontal surface, so that the first housing part provides an upper part of the microphone device and the second housing part provides a lower part of the microphone device.

10. A microphone device according to claim 5, wherein the first and second housing parts are separated by at least one column.

11. A microphone device according to according to claim 1, comprising a further microphone arranged on the centre axis.

12. A microphone device according to claim 1 wherein the number of microphones is four or more.

13. A microphone device according to claim 1, wherein the microphones are arranged on the upper part of the microphone device.
